(19) United States
(12) Patent Application Publication
(10) Pub. No.: US 2013/0101827 A1
(43) Pub. Date: Apr. 25, 2013

(54) OPTICAL CURABLE RESIN COMPOSITE FOR LAMINATING OPTICAL SUBSTRATES AND METHOD THEREOF

(71) Applicant: CHIN-YU CHEN, New Taipei City (TW)

(72) Inventor: CHIN-YU CHEN, New Taipei City (TW)

(21) Appl. No.: 13/277,228

(22) Filed: Oct. 20, 2011

(51) Int. Cl. B32B 7/12; B32B 37/14; B32B 37/12; B32B 37/06; B32B 5/16; G02B 1/00

(52) U.S. Cl. 428/323; 156/275.5

(57) ABSTRACT

In an optical curable resin (OCR) composite for laminating optical substrates and a method of using the OCR composite to laminating two optical substrates, the OCR composite is formed by projecting an ultraviolet light to cure a liquid adhesive containing a plurality of bead-shaped elastic particles, and the method includes the steps of coating the liquid adhesive onto a first optical substrate, stacking the first optical substrate to a second optical substrate, such that each particle is separated between the first and second optical substrates, and projecting the ultraviolet light onto the first and second optical substrate again to cure the liquid adhesive, so that the particles are separated to form a gap with equal heights between the first and second optical substrates to enhance the lamination efficiency and quality of the optical substrates.

### BACKGROUND OF THE INVENTION

1. Field of the Invention

The present invention relates to an optical curable resin (OCR) composite for laminating optical substrates, in particular to the OCR composite that can be cured by projecting an ultraviolet light onto the OCR composite and used for laminating two optical substrates, and a method of laminating two optical substrates by an optical curable resin (OCR) containing elastic particles. The invention also relates to a method of laminating two optical substrates by the OCR composite.

2. Description of the Prior Art

As electronic information blooms, various 3C products tend to have increasingly more diversified and complicated functions and tend to be developed with a light, thin, short and compact design. In directional and conceptual developments of 3C products such as audio/video players, mobile phones and flat PCs, two functions including image display and touch input are integrated into the 3C products to reduce the volume and improve the application of the products significantly. The conventional concept generally adds a spacer into the LCD which is totally different from the application of the present invention. In addition, display and control interfaces of the aforementioned 3C products include an LCD panel and a touch panel laminated integrally with one another, so that a user can use a finger or an operating pen to touch a screen for the operation to provide a more convenient, faster and user-friendly operating mode.

At present, the conventional display panel and touch panel are generally made of a panel-shaped glass optical substrate, and the lamination quality of the optical substrates of the display panel and touch panel affect the image display and touch input functions of the 3C products directly. The conventional methods of laminating optical substrates mainly use a double-sided optical clear adhesive (OCA) or achieve the adhesion by projecting an ultraviolet light to cure an UV glue (such as the OCR).

In the method of using the double-sided OCA, the OCA is attached onto a surface of an optical substrate first, and then another optical substrate is covered onto the OCA, and an external force is applied to laminate the two optical substrates and the OCA between the two optical substrates. However, the drawback of this method resides on that residual stresses are produced during the lamination process of the optical substrates, so that slight errors of non-uniform pressures and unequal compression speeds in different areas may cause an defective of the optical substrates such as Mura, and air bubbles still remain between the two optical substrates easily after the deaeration treatment of the OCA is performed, and the air bubble issue is more significantly for mid to large optical substrates with the size over 5″ LCD display application. As a result, the lamination quality is poor, and the input force, impedance, sensitivity, and line-drawing life of the touch panel are affected adversely.

In the method of using the UV glue, a layer of UV glue is coated on a surface of an optical substrate first, and then another optical substrate is moved onto the UV glue by a mechanical method, and the UV glue is filled between the two optical substrates and precisely controlled to maintain a gap with equal heights by a mechanical method, and an ultraviolet light is projected onto a plurality of endpoints of the optical substrates, such that the optical substrates and the UV glue are pre-cured to facilitate the projection of the ultraviolet light onto the optical substrates at a later stage to cure the UV glue completely. However, this method still has the drawbacks of having a high level of complexity for the mechanical equipments to precisely control the gap with equal heights between the two optical substrates, and incurring a higher production cost. In addition, it takes too much time to project the ultraviolet light to cure the UV glue between the optical substrates, and it is difficult to precisely control the gap with equal heights between the two optical substrates by the mechanical equipment and save the time for waiting the UV glue to be cured, and thus it is difficult to improve the lamination efficiency.

### SUMMARY OF THE INVENTION

Therefore, it is a primary objective of the present invention to provide an OCR composite for laminating two optical substrates and a method of using the OCR composite to laminate the two optical substrates to overcome the following problems of the prior art.

1. After the two optical substrates are laminated, a residual stress is produced, and defects of the optical substrates such as Mura defect and stress marks . . . etc are occur easily.

2. After the deaeration treatment is finished, air bubbles remain between the two optical substrates to cause a poor lamination quality.

3. It is difficult to maintain a uniformity of the height of the lamination gap between the two optical substrates, thus causing a high complexity of the mechanical equipments for maintaining a gap with equal heights between the two optical substrates and incurring a higher production cost.

4. The pending of tact time on the process is relatively too long, and it is difficult to save the time for precisely controlling the mechanical equipment to maintain a gap with equal heights between the two optical substrates and the time for waiting the UV glue to be cured. Thus, it is difficult to improve the lamination efficiency.

To achieve the aforementioned objective, the present invention provides an OCR composite for laminating optical substrates, comprising:

a liquid adhesive, projected with an ultraviolet light to cure the liquid adhesive, and filled between a first optical substrate and a second optical substrate; and

a plurality of bead-shaped elastic particles of the same volume, uniformly mixed into the liquid adhesive, and each of the elastic particles being separated between the first optical substrate and the second optical substrate and disposed on the same plane.

By the aforementioned method, the liquid adhesive is filled between the first and second optical substrates, such that the elastic particles automatically adjust the gap with equal heights between the first and second optical substrates, so as to improve the lamination quality of the optical substrates.

Wherein, the liquid adhesive contains more than ten elastic particles per gram, and the elastic particle has a hardness smaller than or equal to the hardness of the first optical substrate and the second optical substrate, a light transmittance falling within a range from 95% to 100% of the light transmittance of the liquid adhesive, and an index of refraction falling within a range from 1.46 to 1.52. In addition, the size of the particles is controlled very precisely.

In addition, the present invention further provides a method of laminating optical substrates, comprising the steps of:

coating a layer of liquid adhesive onto a surface of a first optical substrate through ultraviolet projection and curing, and the liquid adhesive being mixed with a plurality of bead-shaped solid particles of the same volume;

stacking the first optical substrate with a second optical substrate, such that the liquid adhesive is filled between the first optical substrate and the second optical substrate, and each of the elastic particles is pushed by the first optical substrate and the second optical substrate to move on a same plane, and separated between the first optical substrate and the second optical substrate; and

projecting an ultraviolet light onto the first optical substrate and the second optical substrate to cure the liquid adhesive.

Wherein, the step of projecting the ultraviolet light further comprises the steps of: projecting the ultraviolet light onto a plurality of end points of the first optical substrate and the second optical substrate first, and then projecting the ultraviolet light onto whole surfaces of the first optical substrate and the second optical substrate completely, so as to improve the lamination efficiency of the optical substrates.

Compared with the prior art, the present invention has the following advantages:

1. The optical substrates are stacked and laminated by the weight of the optical substrates without applying other external forces to the optical substrates to prevent residual stresses and defects of the optical substrates such as Mura and poor reflection.

2. The delay air-bubble issue between the optical substrates can be overcome to improve the lamination quality and yield rate of the optical substrates, so as to reduce the material cost and the scrap risk significantly.

3. Due to the bead-shaped elastic particles having a better flexibility and an uneasy stacking feature, a gap equal heights between the first and second optical substrates can be formed to control the lamination gap between the two optical substrates effectively to achieve the best condition of the optical substrates having constant impedance.

4. The equal volume of elastic particles can control the gap of the two optical substrates to simplify the complexity of the mechanical equipment and lower and the production cost for stacking the two optical substrates.

5. A gap height of the elastic particles is defined between the two optical substrates, such that after the ultraviolet light is projected onto the plurality of end points of the optical substrates, the elastic particles are used for supporting two optical substrates to facilitate moving the optical substrates to another place to receive the ultraviolet light again for the full projection, so as to improve the lamination efficiency significantly.

### BRIEF DESCRIPTION OF THE DRAWINGS

FIGS. 1a to 1d are cross-sectional views of a procedure of coating an OCR composite in accordance with the present invention;

FIG. 2 is a partial close-up view of FIG. 1c;

FIG. 3 is a cross-sectional view of another implementation of FIG. 2; and

FIG. 4 is a flow chart of a method in accordance with the present invention.

### DETAILED DESCRIPTION OF THE PREFERRED EMBODIMENTS

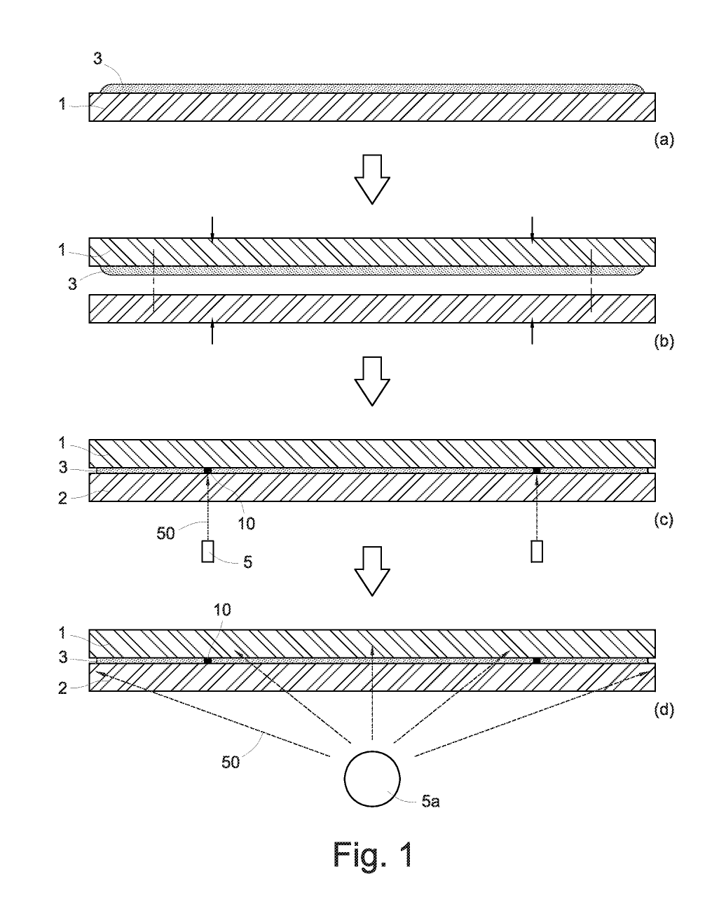

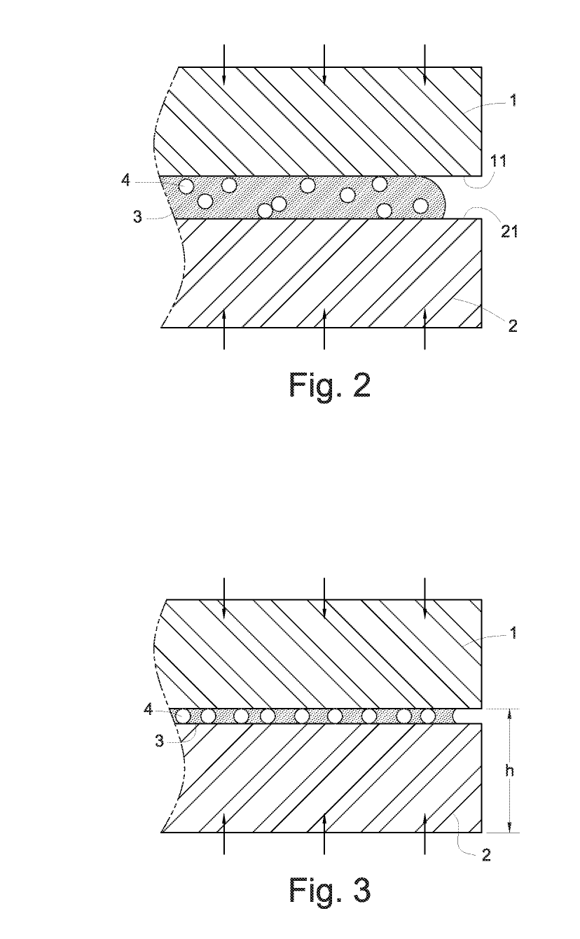

With reference to FIGS. 1a to 1d for cross-sectional views of a procedure of coating an OCR composite in accordance with the present invention and FIGS. 2 and 3 for the OCR composite for laminating the optical substrates in accordance with the present invention, the OCR composite is comprised of a liquid adhesive 3 projected with an ultraviolet light to cure the liquid adhesive 3 and a plurality of bead-shaped solid elastic particles 4 with an equal volume, wherein the liquid adhesive 3 is an OCR liquid composed of poly-silicon oxides, acrylates, methacrylates or epoxy, and provided for filling between a panel-shaped first optical substrate 1 and a panel-shaped second optical substrate 2. In this preferred embodiment, the first and second optical substrates 1, 2 can be the optical substrates for forming the display panel and the touch panel, and the first and second optical substrates 1, 2 can be made of glass or plastic.

The elastic particles 4 are made of plastic, and preferably made of PC or PET.

The elastic particles 4 are mixed uniformly into the liquid adhesive 3, such that each of the elastic particles 4 is separated between the laminating surfaces 11, 21 of the first and second optical substrates 1, 2, and the elastic particles 4 are disposed at positions having a height h on the same plane with respect to the bottom of the second optical substrate 2.

The volume and size of the elastic particles 4 are related to the gap height between the first and second optical substrates 1, 2, and the gap height generally falls within a range from 30 microns to 500 microns. The volume and size of the elastic particles 4 can be manufactured precisely according to a desired gap height, so that the volume and size of each of the elastic particles 4 are consistent.

In another preferred embodiment, the liquid adhesive contains more than ten elastic particles per gram for separating the first and second optical substrates 1, 2 effectively.

In fact, the elastic particles 4 has a hardness smaller than or equal to the hardness of the first and second optical substrates 1, 2 to prevent the elastic particles 4 from rubbing the first and second optical substrates 1, 2 or prevent the surface of the first or second optical substrate 1, 2 from being scratched.

In addition, the elastic particle 4 has a light transmittance falling within a range from 95% to 100% of the light transmittance of the liquid adhesive 3, an index of refraction falling within a range from 1.46 to 1.52, and an index of refraction substantially equal to that of the glass for making the first and second optical substrates 1, 2. By controlling the index of refraction of the elastic particles 4 to adjust and reduce the reflection, a too-large light transmittance or index of refraction between the elastic particle 4 and the liquid adhesive 3 affecting the light transmitting quality of the first and second optical substrates 1, 2 can be avoided.

From the description above, the liquid adhesive 3 is filled between the first and second optical substrates 1, 2, such that the elastic particles 4 can be used for automatically adjusting the gap to have equal heights between the first and second optical substrates 1, 2, such that the solid elastic particles 4 can be added into the liquid adhesive 3, and the liquid adhesive 3 per unit volume has specific height and structural strength. Meanwhile, the solid elastic particles 4 serve as a partition material to define a gap height between the first and second optical substrates 1, 2 to improve the lamination quality of the optical substrates.

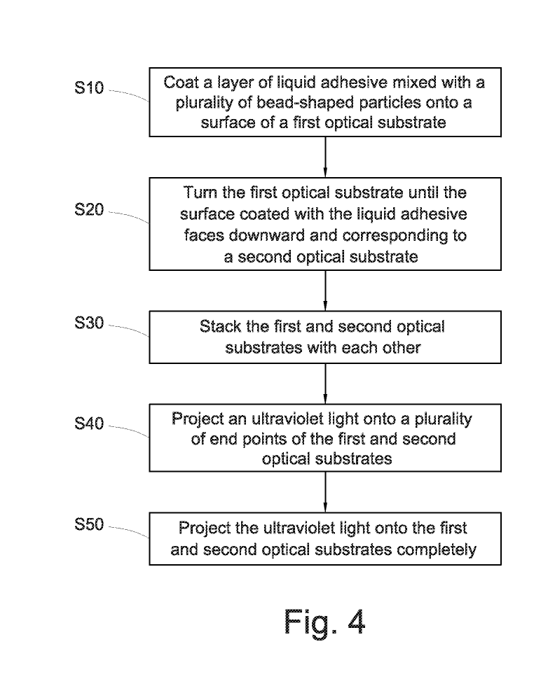

With reference to FIG. 4 for a flow chart of a method of laminating optical substrates in accordance with the present invention, the method is carried out by mechanical equipments including a conventional negative pressure turntable, a conventional negative pressure tray (not shown in the figure) and a conventional UV lamp 5, and the method comprises the following steps:

In Step S10, a layer of liquid adhesive 3 is coated in a form of points or lines or in a shape of a fishbone onto a surface of a panel-shaped first optical substrate 1 by a glue spreading method and a projection of an ultraviolet light for curing the liquid adhesive 3 (as shown in FIGS. 1a and 2). The liquid adhesive 3 is processed by a deaeration treatment and mixed uniformly with a plurality of bead-shaped solid elastic particles 4 with an equal volume. In Step S20, the first optical substrate 1 is turned upside down till the surface of the liquid adhesive 3 coated with the first optical substrate 1 faces downward (as shown in FIG. 1b), and a second optical substrate 2 is moved under the first optical substrate 1, such that the surface of the first optical substrate 1 coated with the liquid adhesive 3 corresponds to the top of the second optical substrate 2.

In Step S30, the second optical substrate 2 is moved upward, such that the top of the second optical substrate 2 is contacted vertically from top to bottom with the surface of the first optical substrate 1 that is coated with the liquid adhesive 3 (as shown in FIGS. 1c, 2 and 3). In the meantime, the first optical substrate 1 is released, so that the first optical substrate 1 is descended by its own weight, and the first and second optical substrates 1, 2 are stacked with each other. With adjusting the glue spreading parameter, the liquid adhesive 3 can be distributed and diffused uniformly and filled between the first and second optical substrates 1, 2, and each of the elastic particles 4 receives a push from the laminating surfaces 11, 21 of the first and second optical substrates 1, 2 to move a position having a height h on the same plane with respect to the bottom of the second optical substrate 2, and each of the elastic particles 4 is separated between the laminating surfaces 11, 21 of the first and second optical substrates 1, 2.

In Step S40, the UV lamp 5 is used for projecting an ultraviolet light 50 onto a plurality of end points 10 on surfaces of the first and second optical substrates 1, 2 (as shown in FIG. 1c) to cure the liquid adhesive 3 at each end point 10 gradually.

In Step S50, before the liquid adhesive 3 at each end point 10 is cured completely, the elastic particles 4 are provided for supporting the first and second optical substrates 1, 2 to facilitate moving the first and second optical substrates 1, 2 outside the mechanical equipment, and using another UV lamp 5a outside the mechanical equipment to project an ultraviolet light 50 onto the whole surfaces of the first and second optical substrates 1, 2 (as shown in FIG. 1d) to cure the liquid adhesive 3 between the first and second optical substrates 1, 2 completely, and the cured liquid adhesive 3 is used for combining the first and second optical substrates 1, 2, so as to facilitate another set of first and second optical substrates 1, 2 to be laminated by the mechanical equipment.

Compared with the prior art, the present invention has the following advantages:

1. The optical substrates 1, 2 are stacked and laminated by the weight of the optical substrates 1, 2 to prevent residual stresses and optical defects of the optical substrates 1, 2.

2. The deaeration treatment can be carried out for the liquid adhesive 3 first to save the vacuum deaeration equipment and time required for the lamination process, so as to reduce the air bubbles hidden between the two optical substrates 1, 2 significantly and improve the lamination quality and yield rate of the optical substrates 1, 2 effectively.

3. Due to the bead-shaped elastic particles 4 having a better flexibility and an uneasy stacking feature, a gap equal heights between the first and second optical substrates 1, 2 can be formed to control the lamination gap between the two optical substrates effectively to achieve the best condition of the optical substrates having constant impedance.

4. The equal volume of elastic particles 4 can control the gap of the two optical substrates 1, 2 to simplify the complexity of the mechanical equipment and lower and the production cost for stacking the two optical substrates.

5. A gap height of the elastic particles 4 is defined between the two optical substrates 1, 2, such that after the ultraviolet light 50 is projected onto the plurality of endpoints 10 of the optical substrates 1, 2, the elastic particles 4 are used for supporting two optical substrates 1, 2 to facilitate moving the optical substrates 1, 2 to another place to receive the ultraviolet light 50 again for the full projection, such that the optical substrates 1, 2 and the liquid adhesive 3 are cured completely, so as to shorten the tact time of the aforementioned mechanical equipment and improve the production capacity per unit time.

What is claimed is:

1. An optical curable resin (OCR) composite for laminating optical substrates, comprising:
a liquid adhesive, projected with an ultraviolet light to cure the liquid adhesive, and filled between a first optical substrate and a second optical substrate; and
a plurality of bead-shaped elastic particles of the same volume, uniformly mixed into the liquid adhesive, and each of the elastic particles being separated between the first optical substrate and the second optical substrate and disposed on the same plane.

2. The optical curable resin (OCR) composite for laminating optical substrates as recited in claim 1, wherein the liquid adhesive contains more than ten elastic particles per gram.

3. The optical curable resin (OCR) composite for laminating optical substrates as recited in claim 1, wherein the elastic particle has a hardness smaller than or equal to the hardness of the first optical substrate and the second optical substrate.

4. The optical curable resin (OCR) composite for laminating optical substrates as recited in claim 1, wherein the elastic particles has a light transmittance falling within a range from 95% to 100% of the light transmittance of the liquid adhesive.

5. The optical curable resin (OCR) composite for laminating optical substrates as recited in claim 1, wherein the elastic particle has an index of refraction falling within a range from 1.46 to 1.52.

6. A method of laminating optical substrates, comprising the steps of:
coating a layer of liquid adhesive onto a surface of a first optical substrate through ultraviolet projection and curing, and the liquid adhesive being mixed with a plurality of bead-shaped solid particles of the same volume;
stacking the first optical substrate with a second optical substrate, such that the liquid adhesive is filled between the first optical substrate and the second optical substrate, and each of the elastic particles is pushed by the first optical substrate and the second optical substrate to move on a same plane, and separated between the first optical substrate and the second optical substrate; and
projecting an ultraviolet light onto the first optical substrate and the second optical substrate to cure the liquid adhesive.

7. The method of laminating optical substrates as recited in claim 6, wherein the step of projecting the ultraviolet light further comprises the steps of projecting the ultraviolet light onto a plurality of end points of the first optical substrate and the second optical substrate first, and then projecting the ultraviolet light onto whole surfaces of the first optical substrate and the second optical substrate completely.
